(19) United States
(12) Patent Application Publication
(10) Pub. No.: US 2021/0004447 A1
(43) Pub. Date: Jan. 7, 2021

(54) SYSTEMS, APPARATUS, AND METHODS FOR CONTROLLING AN OPERATING STATE OF AN ELECTRONIC APPARATUS TO A LOCK STATE

(71) Applicant: LENOVO (Singapore) PTE. LTD., New Tech Park (SG)

(72) Inventor: Kazuhiro Kosugi, Yokohama-shi (JP)

(21) Appl. No.: 16/920,500

(22) Filed: Jul. 3, 2020

(30) Foreign Application Priority Data
Jul. 5, 2019 (JP) 2019-125862

(51) Int. Cl. G06F 21/35; G06F 21/84

(52) U.S. Cl. CPC G06F 21/35; G06F 21/84

(57) ABSTRACT

Systems, apparatus, and methods that control an operating state of an electronic apparatus to a lock state are disclosed. One system includes a signal strength detection unit that detects a signal strength from an external device with which communication is connected wirelessly to an electronic apparatus and an operation control unit that controls an operating state of the electronic apparatus to a lock state based on a comparison between an initial signal strength and a currently detected signal strength. Apparatus and methods include a processor of an information handling device and a memory configured to store code executable by the processor to detect a signal strength from an external device with which communication is connected wirelessly to the information handling device and control an operating state of the information handling device to a lock state based on a comparison between an initial signal strength and a currently detected signal strength.

### REFERENCE TO RELATED APPLICATION

This application claims priority to Japanese Patent Application No. JP2019-125862, filed on Jul. 5, 2019, the contents of which are incorporated herein by reference, in their entirety.

### FIELD

The subject matter disclosed herein relates to computing systems and devices and, more particularly, relates to systems, apparatus, and methods for controlling an operating state of an electronic apparatus to a lock state.

### BACKGROUND

Some conventional computing terminals (e.g., a smartphone) can be carried by a user. The terminals are often paired and/or in communication with another electronic apparatus via, for example, Bluetooth®. Often, the communication state between a terminal and an electronic apparatus is monitored so that when the communication connection between these devices is interrupted, a predetermined lock screen is displayed on the electronic apparatus (see, e.g., Japanese Unexamined Patent Application Publication No. 2018-101161). For example, when the user (and the terminal) is separated from the electronic apparatus by greater than a predetermined distance, the content displayed on the electronic apparatus is automatically controlled to a lock state so that the content displayed on the electronic apparatus cannot be browsed by a third party, which improves the security of the electronic apparatus.

Some issues can arise in Bluetooth® communications because Bluetooth® communication does not generally become interrupted at distances less than about ten meters (10 m), which is too long of a distance for automatically locking an electronic apparatus to ensure the security of the electronic apparatus. Some solutions weaken the signal between an electronic apparatus and a terminal; however, when the strength of a transmitted signal is simply weakened to shorten the distance for automatic locking, the signal may be hindered depending on the surrounding environment or the like. As such, there can be a concern that locking the electronic apparatus may be more easily done accidentally.

### BRIEF SUMMARY

Various embodiments provide systems and apparatus that control an operating state of an electronic apparatus to a lock state. One system includes a signal strength detection unit that detects a signal strength from an external device with which communication is connected wirelessly to an electronic apparatus and an operation control unit that controls an operating state of the electronic apparatus to a lock state based on a comparison between an initial signal strength and a currently detected signal strength.

An apparatus includes a processor of an information handling device and a memory configured to store code executable by the processor. The executable code causes the processor to detect a signal strength from an external device with which communication is connected wirelessly to the information handling device and control an operating state of the information handling device to a lock state based on a comparison between an initial signal strength and a currently detected signal strength.

Other embodiments provide methods for controlling an operating state of an electronic apparatus to a lock state. One method includes detecting, by a sensor of an information handling device, a signal strength from an external device with which communication is connected wirelessly to the information handling device and controlling, by a processor of the information handling device, an operating state of the information handling device to a lock state based on a comparison between an initial signal strength detected at a predetermined time and a currently detected signal strength.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic diagram illustrating one embodiment of an electronic apparatus operating in a normal state;

FIG. 1B is a schematic diagram illustrating the electronic apparatus of FIG. 1A operating in a lock state;

FIG. 2 is a block diagram of one embodiment of the electronic apparatus of FIGS. 1A and 1B;

FIG. 3 is a block diagram of one embodiment of a system processing unit included in the electronic apparatus of FIGS. 1A, 1B, and 2;

FIG. 4 is a schematic flowchart diagram illustrating one embodiment of a method of processing a lock transition for the electronic apparatus of FIGS. 1A, 1B, and 2;

FIG. 5 is a perspective view illustrating an external structure of another embodiment of an electronic apparatus;

FIG. 6 is a schematic diagram illustrating a sensor detection range for a proximity sensor included on the electronic apparatus of FIG. 5;

FIG. 7 is a block diagram of a system processing unit included in the electronic apparatus of FIG. 5; and

FIG. 8 is a schematic flowchart diagram illustrating one embodiment of a method of processing a lock transition for the electronic apparatus of FIG. 5:

FIG. 9 is a flowchart illustrating an example of lock-state transition processing according to the second embodiment.

### DETAILED DESCRIPTION

As will be appreciated by one skilled in the art, aspects of the embodiments may be embodied as an apparatus and/or a system. Accordingly, embodiments may take the form of an entirely hardware embodiment or an embodiment combining hardware and software aspects that may all generally be referred to herein as a “circuit,” “module” or “system.”

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

The present technology has been conceived in view of the issues discussed above in the background section and provides an electronic apparatus and a control method with improved security. That is, the present technology solves at least some of the security problem(s) and/or issue(s) that may be experienced by an electronic apparatus. In various embodiments, an electronic apparatus includes a processing unit that executes system processing based on a system, a signal strength detection unit that detects a signal strength from a device with which communication is connected wirelessly, and an operation control unit that controls the operating state of the system to function in a lock state based on a comparison result between a signal strength detected at a predetermined time and a currently detected signal strength.

In additional or alternative embodiments, the electronic apparatus may be such that the processing unit executes login processing based on authentication processing. The authentication processing may be based on input information and the predetermined time includes the time of a login process.

In further additional or alternative embodiments, the electronic apparatus may further include a person detection unit that detects the approach of a person. Here, the predetermined time includes a timing of when the person detection unit detects the approach of the person.

In other additional or alternative embodiments, the electronic apparatus may be such that the operation control unit displays a preset image on a display unit when functioning in the lock state. The electronic apparatus may also be such that the operation control unit controls the display unit to hide a displayed image when functioning in the lock state.

In some embodiments, the electronic apparatus may further include a storage unit that stores the signal strength detected by the signal strength detection unit at the predetermined time. Here, when the currently detected signal strength decreased by a predetermined amount or more than the signal strength stored by the storage unit, the operation control unit controls the operating state of the system to operate in the lock state.

Further, the electronic apparatus may be such that the signal strength stored by the storage unit is disabled in response to detecting that the electronic apparatus has been relocated or moved. In certain embodiments, the electronic apparatus may further be such that the processing unit releases the lock state based on user authentication processing.

A control method for an electronic apparatus according to various embodiments includes detecting a signal strength, by a signal strength detection unit, emitted from a device with which communication is connected wirelessly to an electronic apparatus. The method further includes controlling, by an operation control unit, the operating state of a system to function in a lock state based on a comparison result between a signal strength detected at a predetermined time and a currently detected signal strength.

In view of the above, various embodiments provide a system and/or device that can the security of an electronic apparatus (e.g., a laptop computing device and a desktop computing device, etc., among other electronic systems, devices, and/or apparatus that are possible and contemplated herein). Various other embodiments provide a method that can improve the security of an electronic apparatus.

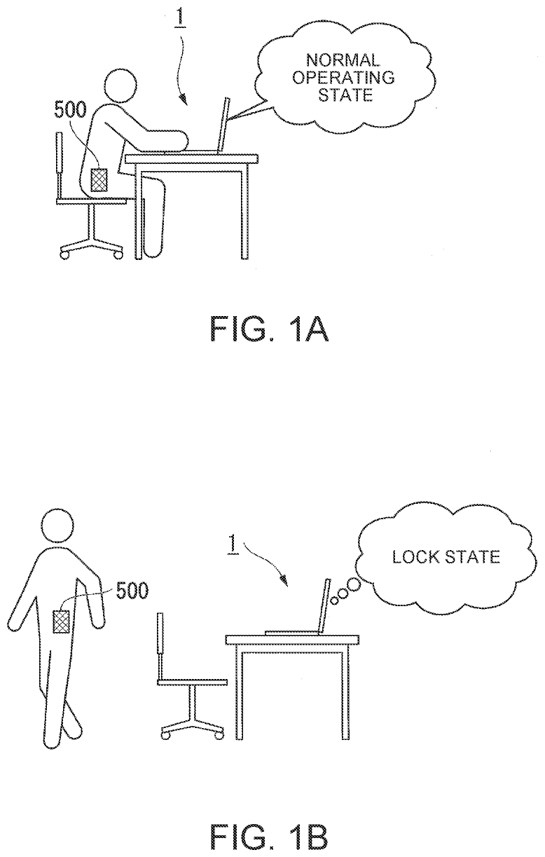

Turning now to the figures, FIG. 1A is a schematic diagram illustrating one embodiment of an electronic apparatus 1 operating in a normal state. Specifically, FIGS. 1A and/or 1B is an illustration of the outline of the electronic apparatus 1 according to the embodiment. The electronic apparatus 1 according to this embodiment is, for example, an information processing apparatus, such as a laptop personal computer (PC). In various other embodiments, the electronic apparatus 1 may be a desktop PC.

Further illustrated in FIGS. 1A and/or 1B is a mobile terminal 500 (e.g., an electronic device) that can be paired with and/or otherwise wirelessly connected/coupled to the electronic apparatus 1. Non-limiting examples of a mobile terminal can include, but are not limited to, a smartphone, a laptop computing device, a personal digital assistant, and a tablet computing device, etc., among other mobile terminals that can be paired with an electronic apparatus that are possible and contemplated herein.

As used herein, pairing includes the ability to perform authentication processing for allowing communication between two electronic apparatuses, devices, and/or systems. Once pairing is completed, information necessary for authentication is stored in both the apparatuses/devices/systems to enable communication on and after without pairing. For example, the electronic apparatus 1 and the mobile terminal 500 are paired wirelessly using near field communication (e.g., Bluetooth®).

As shown in FIG. 1A, a user using the electronic apparatus 1 carries the mobile terminal 500, for example, by putting it in a pocket. The operating state of the system of the electronic apparatus 1 is a “normal” operating state (e.g., a powered-on or ON state). The normal operating state is an operating state capable of executing system processing without being particularly limited, which corresponds to, for example, an S0 state defined in the Advanced Configuration and Power Interface (ACPI) specification. Further, communication between the electronic apparatus 1 and the mobile terminal 500 is established using near field communication. In various embodiments, the electronic apparatus 1 monitors the signal strength from the mobile terminal 500 through this near field communication.

When the user (and the mobile terminal 500) leaves or at least moves away from the electronic apparatus 1, as illustrated in FIG. 1B, the signal strength received by the electronic apparatus 1 from the mobile terminal 500 is lowered and/or decreased. When the signal strength being monitored is lowered/decreased to a level below a certain and/or predetermined level, the electronic apparatus 1 determines that the user (and the mobile terminal 500) has left and/or moved, and causes the operating state of the electronic apparatus 1 to transition from the normal operating state to a lock state. In other words, the electronic apparatus 1 dynamically transitions to the lock state according to and/or in response to the signal strength received from the mobile terminal 500.

In various embodiments, the lock state includes a state incapable of browsing content used by the user on the electronic apparatus 1 and browsing data stored in the electronic apparatus 1 unless some kind of user authentication is performed. Specifically, the lock state includes, for example, a state in which a preset lock screen is displayed, a state of screen off (e.g., hidden display), an OFF screen, a standby state, a sleep state, or the like. For example, the standby state may be modern standby in Windows®. In a further non-limiting example, the sleep state may be an S3 state defined in the ACPI specification.

In various embodiments, the electronic apparatus 1 can be restored from the lock state to the normal operating state utilizing password authentication, face authentication, fingerprint authentication, and/or the like authentication techniques. That is, a user may be required to authenticate the user as an authorized user prior to utilizing the electronic apparatus 1 in the normal operating state after the electronic apparatus has initiated the lock state.

The above-mentioned function for dynamic control of an electronic apparatus in the lock state when the user (and mobile terminal 500) has left or moved away from the electronic apparatus 1 improves the security of the electronic apparatus 1. However, since a transmitted signal from the mobile terminal 500 to the electronic apparatus 1 using a near field communication, such as Bluetooth®, includes a strength that does not generally disable communication at about a distance of about 10 meters, the distance for automatic locking is too long to provide sufficient security.

In some embodiments, the distance for locking the electronic apparatus 1 is shortened by weakening the strength of the signal transmitted from the mobile terminal 500. However, at times the signal may be hindered depending on the surrounding environment, which can result in the electronic apparatus 1 being more easily locked (e.g., erroneous detection is likely to occur and, hence, locking may be done even when the user (and mobile terminal 500) does not leave and/or move away from the electronic apparatus 1). Therefore, in certain embodiments, a threshold value and/or level of the signal strength with which the user is determined to have left and/or moved away from the electronic apparatus 1 (e.g., a determination threshold value and/or level of the signal strength to make the transition to the lock state) is adjusted based on the surrounding environment, the signal situation, and/or the like, rather than weakening the transmitted signal strength. Specifically, the electronic apparatus 1 holds and/or maintains a signal strength detected when the user is actually nearby. Then, when the signal strength drops below the certain and/or predetermined level in comparison with this held signal strength, the electronic apparatus 1 transitions to the lock state.

In a non-limiting example, a successful login to the electronic apparatus 1 is an indication that the user is nearby and/or proximate to the electronic apparatus 1. That is, when a biometric authentication, such as face authentication/recognition, is used to authenticate the user upon login, a determination can be made that the user is nearby and/or proximate to the electronic apparatus 1. Even in the case of password authentication, if the user is authenticated by using a password entered via one or more user operations on an input device 150 (e.g., a keyboard 151 and the like) provided on the electronic apparatus 1 or an input device connected to the electronic apparatus 1, it can be determined that the user is nearby and/or proximate to the electronic apparatus 1.

In some embodiments, the electronic apparatus 1 detects and holds/maintains the signal strength from the mobile terminal 500 at a particular time based on the login processing. The electronic apparatus 1 sets, as a determination threshold value, a lower signal strength, by a predetermined strength or more, than this held/maintained signal strength. The electronic apparatus 1, in various embodiments, monitors the strength of a signal received from the mobile terminal 500 at any time and when the received signal strength (e.g., the current signal strength) becomes less than the determination threshold value, the electronic apparatus 1 transitions to the lock state. In other words, the electronic apparatus 1 calibrates the determination threshold value of the signal strength to determine whether to make the transition to the lock state (e.g., whether the user has left or not) with the signal strength when the user is known to nearby and/or proximate to the electronic apparatus 1 (e.g., when it can be determined that the user is nearby). This process can suppress the influence of one or more changes in signal strength due to the surrounding environment to shorten the distance for the transition to the lock state when the user has left the electronic apparatus 1. Thus, the security of the electronic apparatus 1 can be improved.

In the case of remote access login, since the user is not near the electronic apparatus 1, communication between the electronic apparatus 1 and the mobile terminal 500 is not connected and a determination can be made that this user is not nearby the electronic apparatus 1. Further, when the user does not carry the mobile terminal 500, communication between the electronic apparatus 1 and the mobile terminal 500 is also not connected. In situations in which communication with the mobile terminal 500 is not connected, the electronic apparatus 1 cannot detect the signal strength from the mobile terminal 500 at the time based on the login processing. Here, when the electronic apparatus 1 cannot detect the signal strength from the mobile terminal 500 at the time based on the login processing (e.g., when communication with the mobile terminal 500 is not connected), the electronic apparatus 1 may be controlled to make the transition to the lock state, which is not based on a preset signal strength (e.g., an initial value). For example, when the signal strength from the mobile terminal 500 cannot be detected at the time based on the login processing, the electronic apparatus 1 is not calibrated. Then, after the signal strength from the mobile terminal 500 becomes detectable, the electronic apparatus 1 compares the signal strength with the preset signal strength (e.g., the initial value), and when the signal strength is less than the preset signal strength by the predetermined strength or more, the electronic apparatus 1 transitions to the lock state.

Further, since devices other than the mobile terminal 500 may be paired with the electronic apparatus 1, any of the paired devices can set and used by the electronic apparatus 1 to determine that the user has left and/or moved away from the electronic apparatus 1. Here, the electronic apparatus 1 controls whether to make the transition to the lock state using the signal strength from the specified device (e.g., the mobile terminal 500 or other paired device(s)). The configuration of one embodiment of the electronic apparatus 1 is described below.

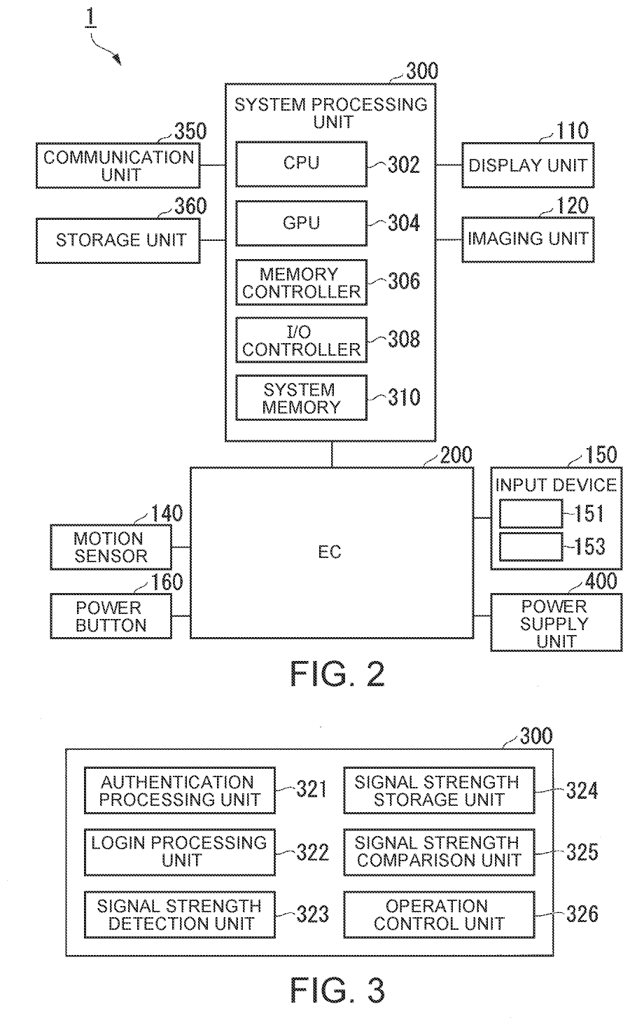

FIG. 2 is a schematic block diagram illustrating a configuration example of the electronic apparatus 1 according to one embodiment. In various embodiments, the electronic apparatus 1 includes a display unit 110, an imaging unit 120, a motion sensor 140, an input device 150, a power button 160, an Embedded Controller (EC) 200, a system processing unit 300, a communication unit 350, a storage unit 360, and a power supply unit 400.

The display unit 110 includes a liquid crystal display (LCD), an organic Electro Luminescence (EL) display, or the like display. The display unit 110 is configured to display data generated and executed by the system processing unit 300.

The imaging unit 120, in certain embodiments, is provided at a position around the display surface of the display unit 110 to capture an image of an object within a predetermined angle of view in a direction (e.g., forward) to face the display surface. The imaging unit 120 outputs the captured image to the system processing unit 300. For example, when the face of a person approaching the electronic apparatus 1 is included within the angle of view of the imaging unit 120, the imaging unit 120 captures a face image of the person and outputs the captured face image to the system processing unit 300. For example, the imaging unit 120 may be a red, green, blue (RGB) camera for capturing RGB images or an infrared (IR) camera for capturing IR images.

The motion sensor 140 includes an acceleration sensor and/or the like sensor. The motion sensor 140 detects the amount and direction of physical motion of the electronic apparatus 1 and outputs, to the EC 200, a detection signal indicative of the detection results. Instead of or in addition to the acceleration sensor, the motion sensor 140 may include a gyro sensor, an inclination sensor, a geomagnetic sensor, or the like sensor.

The input device 150 is an input unit that accepts user inputs, which includes, among other components, the keyboard 151 and a touch pad 153. In response to accepting operations on the keyboard 151 and/or the touch pad 153, the input device 150 outputs, to the EC 200, operation signals indicative of the contents of the operations.

The power button 160 includes an operating element used to accept operations to instruct booting (e.g., power ON) of the system and the transition to the standby state or the sleep state. Note that an instruction to shut down (e.g., power OFF) forcibly may be accepted with a long press or hold of the power button 160. The power button 160 outputs an operation signal to the EC 200 according to the user's operation.

The power supply unit 400 supplies power to each unit of the electronic apparatus 1 through a power system for supplying power to each unit according to the operating state of each unit. The power supply unit 400 includes a direct current-to-direct current (DC/DC) converter. The DC/DC converter, in some embodiments, converts a voltage of AC power, supplied from an alternating current-to-direct current (AC/DC) adapter or a battery pack, to a voltage required for each unit. The power with the voltage converted by the DC/DC converter is supplied to each unit through each power system. For example, the power supply unit 400 supplies power to each unit through each power system based on a control signal according to the operating state of each unit input from the EC 200.

The EC 200 includes a microcomputer configured to include a Central Processing Unit (CPU), a Random-Access Memory (RAM), a Read Only Memory (ROM), an Input/Output (I/O) logic circuit, and the like. The CPU of the EC 200 is configured to read a control program prestored in the ROM and execute the read control program to fulfill the function thereof. The EC 200, in certain embodiments, operates independently of the system processing unit 300 to control the operation of the system processing unit 300 and manage the operating state of the system processing unit 300. As illustrated in FIG. 2, the EC 200 is connected to the motion sensor 140, the input device 150, the power button 160, and the power supply unit 400.

For example, based on an operation on the power button 160, or an operation to the input device 150 for selection from an operation control menu (e.g., lock, logout (e.g., sign-out), sleep, shutdown, restart, or the like) prepared by an operating system (OS), the EC 200 outputs, to the system processing unit 300, a control signal for controlling the operating state of the system. The control signal may include a boot signal for booting the system, a control signal that causes the operating state of the system to make a transition from the normal operating state to the lock state, a logout state, a standby state, or a sleep state, or the like control signal.

In some embodiments, the EC 200 acquires, from the motion sensor 140, a detection signal indicative of the detection result. The EC 200 outputs the acquired detection signal to the system processing unit 300 as necessary. Further, the EC 200 communicates with the power supply unit 400 to acquire information on a battery state (e.g., remaining battery capacity and the like) from the power supply unit 400, and to output, to the power supply unit 400, a control signal or the like to control the supply of power according to the operating state of each unit of the electronic apparatus 1. Further, the EC 200 acquires operation signals from the input device 150 and outputs, to the system processing unit 300, an operation signal related to processing of the system processing unit 300 among the acquired operation signals.

The system processing unit 300, in certain embodiments, is configured to include a CPU 302, a Graphic Processing Unit (GPU) 304, a memory controller 306, an I/O controller 308, and a system memory 310, where processes of various application software are executable on an OS via system processing based on the OS. The CPU 302 and the GPU 304 may be collectively called a processor.

The CPU 302 executes processes by the OS and processes by one or more applications running on the OS. Further, the CPU 302 controls the operating state of the system based on the control signal from the EC 200. For example, when the boot signal is input from the EC 200, the CPU 302 starts boot processing. In the boot processing, the CPU 302 detects and initializes the minimum devices, such as the system memory 310, the storage unit 360, and the like (e.g., a pre-boot). The CPU 302 then loads system firmware from the storage unit 360 into the system memory 310 to detect and initialize the other devices, such as the communication unit 350 and the display unit 110 (e.g., post-processing). Initialization includes processing, such as initial parameter settings. In the case of a transition (e.g., a resume process) from the sleep state to the normal operating state, part of the post-processing may be omitted.

When starting a boot process, the CPU 302 executes a login process before allowing access to the OS, and the execution of the following system processing is paused until a successful login. A login process includes a user authentication process for determining whether a person using the electronic apparatus 1 is a preregistered and/or authorized user. User authentication can include, but is not limited to, password authentication, face authentication, fingerprint authentication, and/or the like authentication. When the login is successful, the CPU 302 resumes execution of the subsequent boot process and causes the operating state of the system to transition to the normal operating state and completes the boot process. The CPU 302 also executes the process for causing the operating state of the system to make a dynamic transition to the lock state, as described above with reference to FIG. 1, the details of which are discussed elsewhere herein (e.g., with reference to FIG. 3).

The GPU 304 is connected to the display unit 110. The GPU 304 executes an image process under the control of the CPU 302 to generate display data. The GPU 304 outputs the generated display data to the display unit 110. Note that the CPU 302 and the GPU 304 may be integrally formed as one core, or the load may be allocated between the CPU 302 and the GPU 304 formed as individual cores, respectively. The number of processors is not limited to one, and various embodiments may include multiple processors.

The memory controller 306 controls reading data from and writing data to the system memory 310, the storage unit 360, and the like by the CPU 302 and the GPU 304. The I/O controller 308 controls the input/output of data from the communication unit 350, the display unit 110, and the EC 200. The system memory 310 is used as a reading area of an execution program of the processor and a working area to write processed data.

The communication unit 350 is communicably connected to one or more other devices through a wireless and/or wired communication network to transmit and receive various data. In various embodiments, the communication unit 350 includes Bluetooth®, a wired LAN interface, such as the Ethernet®, a wireless LAN interface, such as WiFi®, and/or the like. In certain embodiments, the communication unit 350 uses near field communication by Bluetooth to communicate with the mobile terminal 500.

The storage unit 360 includes storage media, such as a Hard Disk Drive (HDD), a secure Non-Volatile RAM (NVRAM), a ROM, and/or the like. The HDD stores the OS, device drivers, various programs (e.g., one or more applications), and various data acquired by the operation of the programs. In the secure NVRAM, authentication data used to authenticate each user is stored. Stored in the authentication data are identification information of each user and authentication information in association with each other. The secure NVRAM is protected (e.g., locked) so as not to be able to be accessed from an OS operating environment via the I/O controller 308. Note, however, that the lock is released upon power ON and reset of the CPU 302, and the system firmware is executed upon completion of the pre-boot to start the lock. Below, a configuration related to lock-state transition processing for making the dynamic transition to the lock state according to the signal strength from the mobile terminal 500 will be described in detail.

FIG. 3 is a block diagram illustrating an example of the functional configuration of the system processing unit 300 according to one embodiment. As an example of a configuration related to the lock state transition process in the functional configuration executed by the CPU 302, the system processing unit 300 includes, among other components, an authentication processing unit 321, a login processing unit 322, a signal strength detection unit 323, a signal strength storage unit 324, signal strength comparison unit 325, and an operation control unit 326.

The authentication processing unit 321 executes one or more user authentication processes for authenticating a user that logs in as an authorized user. In some embodiments, the authentication method includes password authentication and/or face authentication. The authentication method may include any other biometric authentication, such as fingerprint authentication, or may be authentication using an IC tag or RF tag on which authentication information is stored. For example, in the storage unit 360, user authentication information is set for each account as an authorized user that logs in with the account. In the case of password authentication, the user authentication information is a password set by the user, while in the case of face authentication, the user authentication information is information including image feature values of a face image of the authorized user. The user authentication information is stored in association with user information indicative of the user. The user information is, for example, a user name, a user ID, or the like.

In the case of password authentication, the authentication processing unit 321 checks a password entered by the user on the keyboard 151 against the user authentication information stored in the storage unit 360, and when the check results in a match, the authentication processing unit 321 determines that the password authentication is successful. Alternatively, when the check results in a non-match, the authentication processing unit 321 determines that the password authentication is unsuccessful. The authentication processing unit 321 outputs, to the login processing unit 322, the authentication result indicative of success/failure of the password authentication.

In the case of face authentication, the authentication processing unit 321 executes a face authentication process based on a captured image captured by the imaging unit 120. The face authentication processing includes face detection processing and face matching processing. The face detection processing includes processing for defining a face area as an area of a face image from image data of the image captured by the imaging unit 120. The face image includes an image of the face of a person present in front of the electronic apparatus 1. The face matching process includes determining the position(s) of one or more face feature points (e.g., mouth, eyes, nose, etc.) representing the features of the face from the face area, normalizing the position and size of the face area to be predetermined position and size, respectively, and defining a distribution of the normalized face feature points as image feature values, and matching the defined image feature values with image feature values of the face image of a predetermined person to identify the person having image feature values with which matching is successful. The authentication processing unit 321 matches the face image of the person captured by the imaging unit 120 with the user authentication information stored in the storage unit 360, and determines that the face authentication is successful when the results determine a match. On the other hand, when the results determine a non-match, the authentication processing unit 321 determines that the face authentication is unsuccessful. The authentication processing unit 321 outputs, to the login processing unit 322, the authentication result indicative of success/failure of the face authentication.

The login processing unit 322 executes a login process to log in a user based on the authentication result by the authentication processing unit. When starting a boot process, the login processing unit 322 instructs the authentication processing unit 321 to execute the authentication process before allowing access to the OS, and the subsequent boot process is paused. When the authentication result by the authentication processing unit 321 is successful, the login processing unit 322 allows the login and resumes the execution of the paused boot process to execute the login process. On the other hand, when the authentication result by the authentication processing unit 321 is unsuccessful, the login processing unit 322 makes a notification that the login is not allowed and leaves the execution of the boot process paused.

The signal strength detection unit 323 detects the signal strength from the mobile terminal 500 with which communication is connected to the electronic apparatus 1 using the near field communication. For example, the signal strength detection unit 323 detects the signal strength at a particular time based on the login process. More specifically, the signal strength detection unit 323 detects the signal strength at the time of a successful user login. Thus, the signal strength detection unit 323 can detect the signal strength from a mobile terminal 500 (e.g., the mobile terminal 500 carried by an authorized user) that is near the electronic apparatus 1. When the signal strength from the mobile terminal 500 is reduced and/or weakens from the initially detected signal strength by a predetermined amount, a determination is made that the user has left or is no longer proximate to the electronic apparatus 1. In some embodiments, the signal strength detection unit 323 regularly detects the signal strength from the mobile terminal 500 at predetermined intervals of time after the electronic apparatus 1 is booted up.

The signal strength storage unit 324 stores, in the storage unit 360, the signal strength detected by the signal strength detection unit 323. The signal strength comparison unit 325 is configured to compare the signal strengths detected by the signal strength detection unit 323 at the regular intervals (e.g., the current signal strengths) with the stored initial signal strength detected at login to determine whether there is a difference in signal strengths. In some embodiments, the signal strength comparison unit 325 determines whether the current signal strength is the same or has been reduced/weakened by the predetermined strength or more, than the initial signal strength detected at the login process. Note that “reduced/weakened” may include a predetermined amount and/or a predetermined percentage or more.

The operation control unit 326 controls the operating state of the electronic apparatus 1 to the lock state based on the comparison result determined by the signal strength comparison unit 325. In other words, the operation control unit 326 controls the operating state of the electronic apparatus 1 to the lock state based on the comparison result between the initial signal strength detected the login process and the currently detected signal strength. In some embodiments, when the currently detected signal strength is lower than the initial signal strength (e.g., stored in the signal strength storage unit 324) by the predetermined strength amount or more, the operation control unit 326 controls the operating state of the electronic apparatus 1 to operate in the lock state. When controlling the operating state of the electronic apparatus 1 to the lock state, the operation control unit 326 may display a preset lock image on the display unit 110 or may control the display unit 110 to hide data on the display.

Further, the operation control unit 326 releases the lock state in response to a successful user authentication process (e.g., via password authentication or face authentication). In certain embodiments, when the authentication result by the authentication processing unit 321 is successful in the lock state, the operation control unit 326 releases the lock state of the electronic apparatus 1 and transitions operations in the electronic apparatus 1 to the normal operating state. Below, the operation of the lock-state transition process in the electronic apparatus 1 is described.

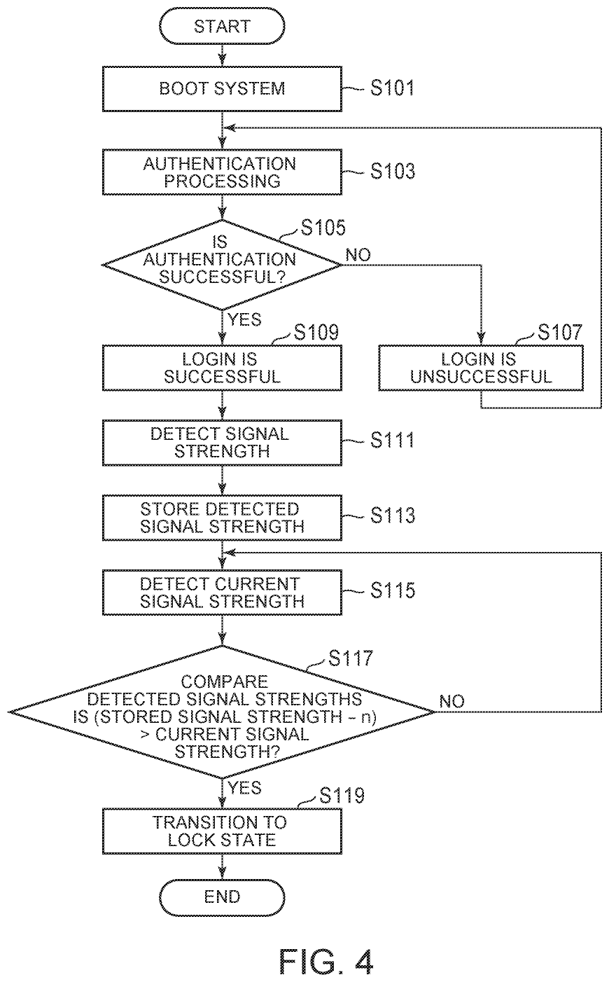

FIG. 4 is a flowchart diagram illustrating an example of the lock-state transition processing according to one embodiment. In response to a user's operation of the power button 160, the EC 200 outputs, to the system processing unit 300, a boot signal for booting the electronic apparatus 1 (block S101). Further, the EC 200 outputs, to the power supply unit 400, a control signal to supply power necessary for the operation of each unit of the electronic apparatus 1. When acquiring the boot signal, the system processing unit 300 starts the boot process (block S101) and the system processing unit 300 initiates an authentication process (block S103).

The system processing unit 300 starts the login process to execute the user authentication processing. In various embodiments, the system processing unit 300 executes user authentication processing, by face authentication based on a captured image acquired from the imaging unit 120, to determine whether there is a successful authentication (block S105).

In response to determining that the authentication result is unsuccessful (e.g., a “NO” in block S105), the system processing unit 300 determines that the login is unsuccessful and/or denies access to the user (block S107). Further, in response to determining that the authentication result is successful (e.g., a “YES” in block S105), the system processing unit 300 successfully logs in the user (block S109).

In response to an unsuccessful login, the system processing unit 300 gives a notification that the login is unsuccessful (e.g., displays the notification on the display unit 110) and returns to the authentication processing in block S103. In response to a predetermined number of unsuccessful login attempts, the system processing unit 300 may stop the authentication processing and make a transition to a state of disabling the login authentication process.

In response to a successful login, the system processing unit 300 gives a notification that the login is successful (e.g., displays a notification on the display unit 110) to continue the boot process. Subsequently, the system processing unit 300 detects a signal strength from the paired mobile terminal 500 (block S111). Next, the system processing unit 300 proceeds to store the detected signal strength in the storage unit 360 (block S113).

The system processing unit 300 regularly detects the current signal strength from the mobile terminal 500 at predetermined intervals after booted up (e.g., monitors the signal strength) (block S115). Subsequently, the system processing unit 300 compares the current signal strength detected at the regularly predetermined intervals with the initial signal strength stored in the storage unit 360 to determine whether the initial signal strength is greater than the current signal strength (block S117). For example, the system processing unit 300 determines whether the current signal strength is less than the initial signal strength by the predetermined strength or more ((stored signal strength−n)>current signal strength). Here, “n” indicates the above “predetermined strength,” and the “stored signal strength−n” corresponds to the determination threshold value used to determine whether the user (and the mobile terminal 500) has left or not (e.g., whether to make the transition to the lock state or not). In response to the current signal strength not being less than the stored signal strength by the predetermined strength or more (e.g., a “NO” in block S117), the system processing unit 300 returns to the processing in block S115 to detect the current signal strength (e.g., continues to monitor the signal strength). On the other hand, in response to the current signal strength being less than the stored signal strength by the predetermined strength or more (e.g., a “YES” in block S117), the system processing unit 300 proceeds to control the operating state of the electronic apparatus 1 to operate in the lock state (block S119).

When no signal strength from the mobile terminal 500 can be detected at the time of a successful login or at an initial time (e.g., when no signal strength can be detected in block S111 of FIG. 4), the system processing unit 300 may compare, in block S117, the current signal strength detected at the regularly predetermined intervals with a preset and/or predetermined signal strength. In other words, when no signal strength can be detected at the initial time or at a login process, the system processing unit 300 may detect the leave of a user using the initially set determination threshold value without performing a calibration and make the transition to the lock state based thereon.

Depending on the operating state of the system before the boot processing, the communication with the mobile terminal 500 may not be established at the time of a successful login. Here, the system processing unit 300 may continue to detect the signal strength from the mobile terminal 500 until a predetermined time has elapsed after the time of a successful login and/or may detect the signal strength from the mobile terminal 500 upon the lapse of a predetermined time after the time of a successful login.

As described above, the electronic apparatus 1 according to one embodiment includes the system processing unit 300 (an example of a processing unit), the signal strength detection unit 323, and the operation control unit 326. The system processing unit 300 executes system processing. The signal strength detection unit 323 detects the signal strength from a device with which communication is connected wirelessly with the electronic apparatus 1 (e.g., via Bluetooth®). Based on the comparison result between the signal strength, detected by the signal strength detection unit 323 at a predetermined time and the currently detected signal strength, the operation control unit 326 controls the operating state of the electronic apparatus 1 to the lock state.

Since the actually detected signal strength is used to calibrate the determination threshold value used to determine whether the user has left or not, the electronic apparatus 1 can shorten or decrease the distance used to determine that the user has left while considering the influence of the surrounding environment on the signal strength or the like. Thus, since the distance for automatic locking when the user has left the electronic apparatus 1 can be made shorter than the conventional techniques, security can be improved in the electronic apparatus 1.

In various embodiments, the above-mentioned predetermined time is a time based on a login process. The system processing unit 300 executes the login process based on the face authentication processing (an example of authentication processing) based on a face image (an example of input information). The time based on the login process is the time is based on, for example, the matching result of a face authentication (e.g., a successful login). Since the communication with the mobile terminal 500 may be disconnected upon login, the time based on the login process may be a time based upon the lapse of a predetermined time (e.g., three minutes among other amounts of time greater than or less than three minutes that are possible and contemplated herein) after the login time or may be a time based on the fact that the communication with the mobile terminal 500 is established after the login.

Since the electronic apparatus 1 calibrates the determination threshold value to determine whether the user is nearby or not using the signal strength detected at the time of a login process (that is, the signal strength when the user is in close range), the distance used to determine that the user has left can be set shorter of smaller while considering the influence of the surrounding environment or the like. Thus, the distance for automatic locking when the user has left the electronic apparatus 1 can be made shorter or smaller than conventional techniques, and hence security of the electronic apparatus 1 can be improved.

The authentication processing upon login may be a authentication process using any biometric authentication, such as fingerprint authentication, instead of or in addition to the face authentication. Further, the authentication process upon login may be a authentication process using password authentication instead of or in addition to the biometric authentication. Further, in the case of remote access login to the electronic apparatus 1, since the user is far away from the electronic apparatus 1, the electronic apparatus 1 does not have to calibrate the determination threshold value mentioned above.

Further, the operation control unit 326 may display, on the display unit 110, a preset image (e.g., lock image) in the lock state. Here, when the user has left the electronic apparatus 1, since the preset image is displayed on the display unit 110 instead of content that has been displayed, the electronic apparatus 1 can improve security to prevent the content from being browsed by an unauthorized third party.

Note that the operation control unit 326 may control the display unit 110 to hide the data on the display in the lock state. Here, in response to the user leaving the electronic apparatus 1, since the display of content that has been displayed is switched to be hidden so that the content is made invisible, the electronic apparatus 1 can improve security to prevent the content from being browsed by an unauthorized third party.

Further, the electronic apparatus 1 may include the signal strength storage unit 324 (an example of a storage unit) to store a signal strength detected by the signal strength detection unit 323 at a predetermined time. Subsequently, the operation control unit 326 may control the operating state of the electronic apparatus 1 to function in the lock state when the currently detected signal strength becomes a signal strength that is lower, by the predetermined strength or more, than the initial signal strength stored by the signal strength storage unit 324. Here, since the electronic apparatus 1 controls the transition to the lock state using the signal strength actually detected when the user is nearby, the distance for control to the lock state when the user has left the electronic apparatus 1 can be made shorter or smaller than conventional techniques, and hence security of the electronic apparatus 1 can be improved.

In response to the electronic apparatus 1 being moved from a location where the calibration has been performed, since the surrounding signal environment may change, there is a concern that control to the lock state cannot be performed properly. Therefore, the electronic apparatus 1 may detect whether the electronic apparatus 1 is moved or not based on the detection result of the motion sensor 140. Here, in response to detecting the movement of the electronic apparatus 1, the signal strength stored in the storage unit 360 may be reset (e.g., disabled). In other words, in response to detecting the movement of the electronic apparatus 1, the electronic apparatus 1 may reset (e.g., disable) the calibration result of the determination threshold value to determine whether the user has left the electronic apparatus 1 or not. Here, the electronic apparatus 1 may control whether the user has left the electronic apparatus 1 or not (that is, whether to make the transition to the lock state or not) based on a preset signal strength (e.g., initial value) to perform a calibration at the time based on the next login process. The process of resetting (e.g., disabling) the calibration result may include erasing the data on the signal strength stored in the storage unit 360 or to disable the data on the signal strength stored without being erased.

In some embodiments, in response to the amount of movement detected by the motion sensor 140 exceeding a preset threshold value, the electronic apparatus 1 detects that the electronic apparatus 1 is moved. This threshold value is preset as a threshold value for determining whether the electronic apparatus 1 is moved or not. For example, this threshold value is preset as a threshold value for a moving distance that can affect a person detection range.

Further, the system processing unit 300 may release the above-mentioned lock state based on the user authentication processing. Thus, since the electronic apparatus 1 performs control to the lock state while the user is being away from the electronic apparatus 1, security in the electronic apparatus 1 can be improved. Next, other embodiments of the present technology will be described.

In the above embodiments, the time based on the login process is used as the time of detecting the signal strength when the user is nearby, while in other embodiments, an example of detecting that the user is nearby will be described.

An electronic apparatus 1A according to some embodiments includes a proximity sensor to be described later to detect a person present in the neighborhood of the electronic apparatus 1A. The process for detecting the presence of a person may also be called Human Presence Detection (HPD) processing. For example, when a change is made from a state where no person is detected in the neighborhood or environment of the electronic apparatus 1A to a state where a person is detected, the electronic apparatus 1A detects that the person approaches the electronic apparatus 1A (e.g., Approach). Further, the electronic apparatus 1A detects a state where a person is present in front of the electronic apparatus 1A (e.g., Presence) while the state of detecting the person in the neighborhood or environment of the electronic apparatus 1A continues. Note that when a change is made from the state of detecting the presence of the person (Presence) to the state where no person is detected in the neighborhood of the electronic apparatus 1A, the electronic apparatus 1A may detect that the person has left the electronic apparatus 1A (e.g., Leave). Further, the electronic apparatus 1A may detect the person present in the neighborhood of the electronic apparatus 1A to control the operating state of the system based on the detection result. For example, when detecting that the person approaches the electronic apparatus 1A (Approach), the electronic apparatus 1A automatically boots the system.

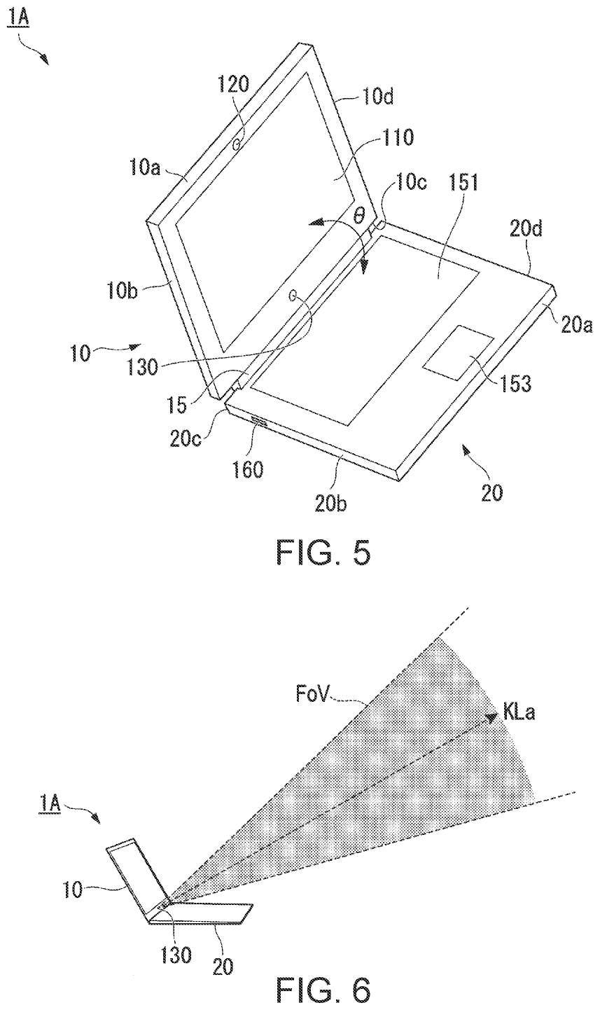

The configuration of the electronic apparatus 1A according to the embodiment will be described below with reference to FIG. 5 through FIG. 7. In the configuration of the electronic apparatus 1A according to various embodiments, units corresponding to those in the electronic apparatus 1 of the first embodiment are given the same reference numerals.

FIG. 5 is a perspective view illustrating an external structure example of the electronic apparatus 1A according to various embodiments. The electronic apparatus 1A includes a first chassis 10, a second chassis 20, and a hinge mechanism 15. The first chassis 10 and the second chassis 20 are coupled by using the hinge mechanism 15. The first chassis 10 is rotatable around an axis of rotation formed by the hinge mechanism 15 relative to the second chassis 20. The direction of the axis of rotation is parallel to side faces 10c and 20c on which the hinge mechanism 15 is placed.

The first chassis 10 is also called A cover or a display chassis. The second chassis 20 is also called C cover or a system chassis. In the following description, side faces on which the hinge mechanism 15 are provided among side faces of the first chassis 10 and the second chassis 20 are referred to as the side faces 10c and 20c, respectively. Among the side faces of the first chassis 10 and the second chassis 20, faces opposite to the side faces 10c and 20c are referred to as side faces 10a and 20a, respectively. In this figure, the direction from the side face 20a toward the side face 20c is referred to as “rear,” and the direction from the side face 20c toward the side face 20a is referred to as “front.” The right hand and left hand in the rearward direction are referred to as “right” and “left,” respectively. The left side faces of the first chassis 10 and the second chassis 20 are referred to as side faces 10b and 20b, respectively, and right side faces are referred to as side faces 10d and 20d, respectively. Further, a state where the first chassis 10 and the second chassis 20 overlap each other and are completely closed (a state of open angle θ=0°) is referred to as a “closed state.” The faces of the first chassis 10 and the second chassis 20 on the face-to-face sides in the closed state are referred to as “inner faces,” and the faces opposite to the inner faces are referred to as “outer faces,” respectively. Further, a state opposite to the closed state, where the first chassis 10 and the second chassis 20 are open, is referred to as an “open state.”

The external appearance of the electronic apparatus 1A in FIG. 5 illustrates an example of the open state. The open state is a state where the side face 10a of the first chassis 10 and the side face 20a of the second chassis 20 are separated. In the open state, the inner faces of the first chassis 10 and the second chassis 20 appear so that the electronic apparatus 1 is expected to be able to carry out normal operation. The open state is a state where the open angle θ between the inner face of the first chassis 10 and the inner face of the second chassis 20 is equal to or more than a predetermined angle, typically about 100° to 130°. Note that the range of open angles θ to be the open state can be set arbitrarily according to the range of angles rotatable by the hinge mechanism 15, or the like.

The display unit 110 is provided on the inner face of the first chassis 10. The imaging unit 120 and a proximity sensor 130 are provided in a peripheral area of the display unit 110 on the inner face of the first chassis 10. The imaging unit 120 is arranged on the side of the side face 10a in the peripheral area of the display unit 110. The proximity sensor 130 is arranged on the side of the side face 10c in the peripheral area of the display unit 110.

In the open state, the imaging unit 120 captures an image of an object within a predetermined angle of view in a direction (e.g., frontward) to face the inner face of the first chassis 10. The predetermined angle of view is an imaging angle of view defined by an image sensor included in the imaging unit 120 and an optical lens provided in front of an imaging surface of the image sensor.

The proximity sensor 130 detects an object (e.g., a person) present in the neighborhood or environment of the electronic apparatus 1A. For example, the proximity sensor 130 includes an infrared (IF) distance sensor configured to include a light-emitting part for emitting infrared light and a light-receiving part for receiving reflected light which is the infrared light returned after being emitted and reflected on the surface of the object. The proximity sensor 130 detects, with a predetermined sampling frequency (e.g., 1 Hz among other frequencies greater than or less than 1 Hz that are possible and contemplated herein), light received by the light-receiving part, and outputs a detection signal according to the distance to the object (e.g., the person) by using a triangulation method for calculating the distance based on the imaging position of the received light or a Time of Flight (ToF) process for converting, to a distance, a time difference from light-emitting to light-receiving, or the like.

FIG. 6 is a schematic diagram illustrating a sensor detection range of the proximity sensor 130. In the open state, the proximity sensor 130 arranged on the inner face of the first chassis 10 detects an object (e.g., a person) in a direction (e.g., frontward) to face the inner face of the first chassis 10. A detection field of view (FoV) indicates an angle detectable by the proximity sensor 130. A detection limit distance KLa indicates a limit distance detectable by the proximity sensor 130. A range defined by the detection field of view FoV (e.g., 25° to 30°) and the detection limit distance KLa (e.g., 120 cm) is the sensor detection range detectable by the proximity sensor 130.

Note that the proximity sensor 130 may be a sensor using infrared light emitted by a light-emitting diode, or a sensor using infrared laser emitting a light beam narrower in wavelength band than the infrared light emitted by the light-emitting diode. Further, the proximity sensor 130 is not limited to the infrared distance sensor, and it may be a sensor using any other method, such as an ultrasonic sensor or a sensor using an Ultra-Wide Band (UWB) radar, as long as the sensor detects a distance to the object.

With reference again to FIG. 5, the power button 160 is provided on the side face 20b of the second chassis 20. Further, the keyboard 151 and the touch pad 153 are provided as an input device on the inner face of the second chassis 20. Note that a touch sensor may be included as the input device instead of or in addition to the keyboard 151 and the touch pad 153, or a mouse and an external keyboard may be connected. When the touch sensor is provided, an area corresponding to the display surface of the display unit 110 may be configured as a touch panel for accepting operations. Further, a microphone used to input voice may be included in the input device.

In the closed state where the first chassis 10 and the second chassis 20 are closed, the display unit 110, the imaging unit 120, and the proximity sensor 130 provided on the inner face of the first chassis 10 are covered with the inner face of the second chassis 20, and put in a state of being disabled from fulfilling the functions thereof. In the state where the first chassis 10 and the second chassis 20 are completely closed, the open angle θ is 0°.

Note that the external structure of the electronic apparatus 1A illustrated in FIG. 5 can also be taken completely as an example of the external structure of the electronic apparatus 1 of the first embodiment. Alternatively, the external structure of the electronic apparatus 1A except the proximity sensor 130 may be taken as an example of the external structure of the electronic apparatus 1 of the first embodiment.

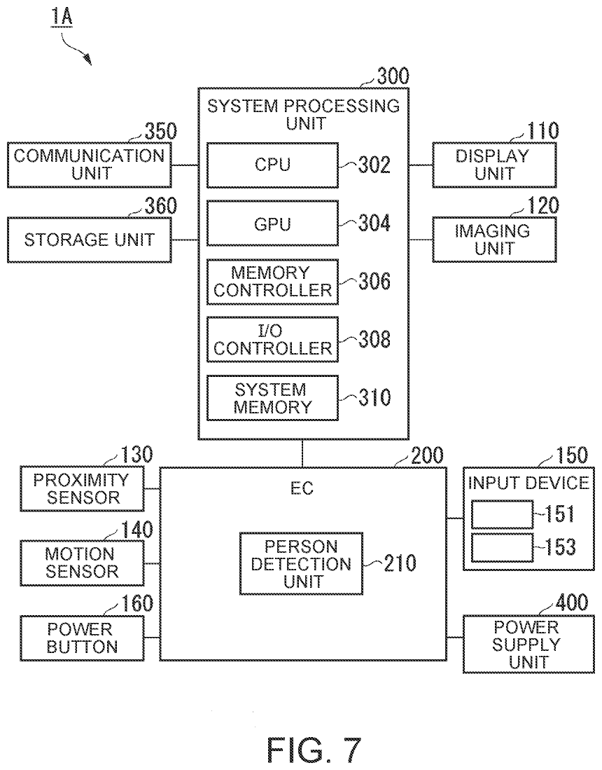

FIG. 7 is a schematic block diagram illustrating a configuration example of the electronic apparatus 1A according to various embodiments. The electronic apparatus 1A is configured to include the display unit 110, the imaging unit 120, the proximity sensor 130, the motion sensor 140, the input device 150, the EC 200, the system processing unit 300, the communication unit 350, the storage unit 360, and the power supply unit 400. The configuration of the electronic apparatus 1A illustrated in FIG. 7 is different from the configuration of the electronic apparatus 1 illustrated in FIG. 2 in that the proximity sensor 130 is provided and the EC 200 includes a person detection unit 210.

The proximity sensor 130 detects an object (e.g., a person) present in a direction (e.g., frontward) to face the inner face of the first chassis 10, and outputs, to the EC 200, a detection signal indicative of the detection result. The person detection unit 210 of the EC 200 detects a person present in front of the electronic apparatus 1A based on the detection result detected by the proximity sensor 130 with a predetermined sampling frequency (e.g., 1 Hz). For example, based on the detection signal acquired from the proximity sensor 130, the person detection unit 210 detects the distance to the person present within a predetermined range in front of the electronic apparatus 1A. The predetermined range is a person detection range set as a range in which the person detection unit 210 detects a person. The person detection range is a range defined by the detection field of view indicative of the angle of view as a detection target and the maximum detection distance indicative of the distance as a detection target.

In certain embodiments, the person detection range corresponds to the sensor detection range of the proximity sensor 130. Specifically, for example, the detection field of view in the person detection range corresponds to the detection FoV (see, FIG. 6) of the proximity sensor 130. Further, for example, the maximum detection distance in the person detection range corresponds to the detection limit distance KLa (see, FIG. 6) of the proximity sensor 130. Note that the person detection range may be a range as part of the sensor detection range of the proximity sensor 130, or a limitation on the maximum detection distance or the minimum detection distance may be set. In other words, the person detection unit 210 may detect the person by setting a preset range in the sensor detection range of the proximity sensor 130 as the person detection range.

In some embodiments, based on the detection signal acquired from the proximity sensor 130, the person detection unit 210 detects whether an object (e.g., a person) is present within the person detection range or not, and when the object (e.g., the person) is present, the person detection unit 210 detects the distance from the proximity sensor 130 to the object (e.g., the person). In the following description, the fact that the person detection unit 210 detects an object (e.g., a person) may be simply mentioned as, “the person detection unit 210 detects a person.” In other words, the fact that the person detection unit 210 detects a person includes both that the person detection unit 210 detecting a person and the person detection unit 210 detecting an object other than the person. Specifically, when acquiring a detection signal according to the distance to a person acquired from the proximity sensor 130, the person detection unit 210 detects that the person is present within the person detection range and detects the distance to the person. On the other hand, when the detection signal according to the distance to the person cannot be acquired from the proximity sensor 130, the person detection unit 210 detects that no person is present within the person detection range.

Further, when a person is detected after no person is detected within the person detection range, the person detection unit 210 may determine that the person approaches in front of the electronic apparatus 1 and detects the approach of the person to the electronic apparatus 1A. Further, when a person is being continuously detected after the person is detected within the person detection range, the person detection unit 210 may detect a state where the person is present in front of the electronic apparatus 1A. Further, when the person is no longer detected after the person is being detected within the person detection range, the person detection unit 210 may determine that the person present in front of the electronic apparatus 1A has left and detect the leave of the person from the electronic apparatus 1A.

The person detection unit 210 outputs the detection result to the system processing unit 300. The operation control unit 326 of the system processing unit 300 (see, FIG. 3) may control the operating state of the system based on the detection result by the person detection unit 210. For example, in the standby state or the sleep state of the system, when the person detection unit 210 detects a person after detecting no person within the person detection range (that is, when the person detection unit 210 detects the approach of the person to the electronic apparatus 1A), the operation control unit 326 may boot the system.

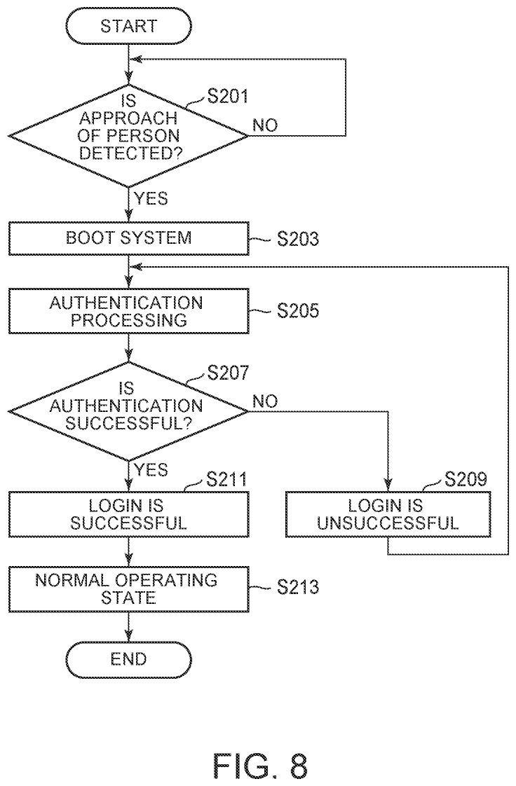

Referring to FIG. 8, the operation of boot processing to boot the system in response to the fact that the electronic apparatus 1A detects the approach of a person will be described. FIG. 8 is a flowchart diagram illustrating an example of boot control according to various embodiments. Here, it is assumed that the electronic apparatus 1A is placed open on a desk or the like in the standby state or the sleep state.

Based on a detection signal acquired from the proximity sensor 130, the EC 200 determines whether the approach of a person to the electronic apparatus 1A is detected or not (block S201). In response to a person being detected after no person is detected within the person detection range, the EC 200 determines that the approach of the person to the electronic apparatus 1A is detected. Further, in response to no person remaining detected within the person detection range, the EC 200 determines that the approach of a person to the electronic apparatus 1A is not detected. Then, in response to determining that the approach of a person to the electronic apparatus 1A is not detected (e.g., a “NO” in block S201), the EC 200 performs the processing in block S201 again. On the other hand, in response to determining that the approach of a person to the electronic apparatus 1A is detected (e.g., a “YES” in block S201), the EC 200 outputs, to the system processing unit 300, a boot signal to boot the system (block S203).

In some embodiments, the EC 200 outputs, to the power supply unit 400, a control signal to supply power necessary for the operation of each unit of the electronic apparatus 1A. In response to acquiring the boot signal, the system processing unit 300 starts the boot processing.

The system processing unit 300 starts login processing to execute user authentication processing. In various embodiments, the system processing unit 300 executes user authentication processing by face authentication based on a captured image acquired from the imaging unit 120 (block S205).

The system processing unit 300 determines whether the authentication result is successful or not (block S207). In response to determining that the authentication result is unsuccessful (e.g., a “NO” in block S207), the system processing unit 300 determines an unsuccessful login (block S209). On the other hand, in response to determining that the authentication result is successful (e.g., a “YES” in block S207), the system processing unit 300 determines a successful login (block S211).

In response to the authentication result being unsuccessful (block S209), the system processing unit 300 gives a notification that the login is unsuccessful (e.g., displays the notification on the display unit 110) and returns to the authentication processing (block S205). When the authentication processing is unsuccessful for a predetermined number of times or attempts, the system processing unit 300 may stop the authentication processing and make a transition to a state of disabling the login authentication processing.

In response to the authentication result being successful (block S211), the system processing unit 300 gives a notification that the login is successful (e.g., displays the notification on the display unit 110) to continue the boot process. The system processing unit 300 then completes the boot process and makes a transition to the normal operating state (block S213). Below, the operation of lock-state transition processing according to certain embodiments is described.

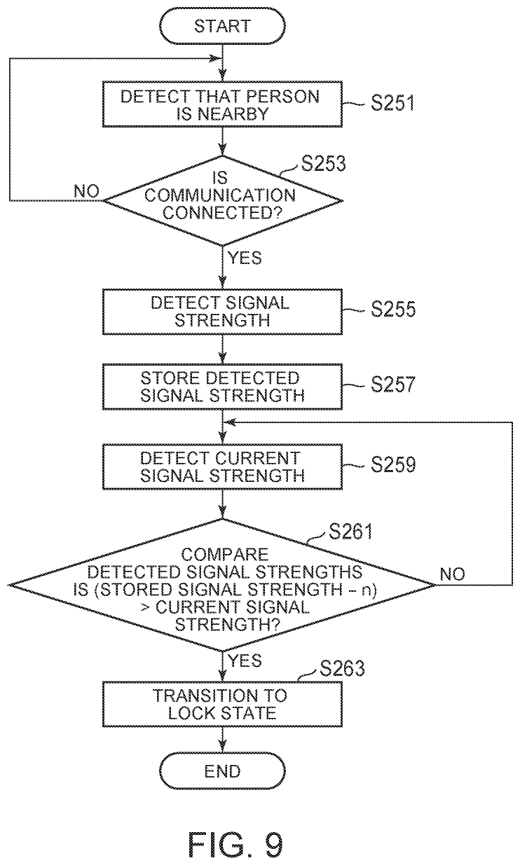

FIG. 9 is a flowchart diagram illustrating an example of the lock-state transition processing according to some embodiments. Based on the detection signal acquired from the proximity sensor 130, the EC 200 detects that a person is present within the person detection range (e.g., a person is nearby) (block S251). In various embodiments, in response to detecting the approach of a person to the electronic apparatus 1A, the EC 200 outputs the detection result to the system processing unit 300.

The system processing unit 300 determines whether the communication with the mobile terminal 500 (e.g., a specific paired device) is connected or not (that is, whether the communication is established or not) (block S253). In response to determining that the communication with the mobile terminal 500 is not connected to the electronic apparatus 1 (e.g., a “NO” in block S253), the system processing unit 300 returns to the processing in block S251. In response to determining that the communication with the mobile terminal 500 is not connected, there is a possibility that the person nearby will not be an authorized user of the electronic apparatus 1A. On the other hand, in response to determining that the communication with the mobile terminal 500 is connected to the electronic apparatus 1 (e.g., a “YES” in block S253), the system processing unit 300 detects the signal strength from the paired mobile terminal 500 (block S255).

The system processing unit 300 stores, in the storage unit 360, the detected signal strength (block S257). After bootup, the system processing unit 300 detects the current signal strength (e.g., monitors the signal strength) from the mobile terminal 500 at regular predetermined intervals (block S259).

The system processing unit 300 compares the current signal strength detected at the regular predetermined intervals with the signal strength stored in the storage unit 360 (block S261). In certain embodiments, the system processing unit 300 determines whether the current signal strength is made lower, by a predetermined strength or more, than the stored signal strength ((stored signal strength−n)>current signal strength) or not. Here, “n” indicates the “predetermined strength” mentioned above, and the “stored signal strength—n” corresponds to the determination threshold value used to determine whether the user has left or not (e.g., whether to make the transition to the lock state or not). In response to the current signal strength not being lower than or less than, by the predetermined strength or more, than the stored signal strength (that is, the current signal strength is equal to or more than the threshold value) (e.g., a “NO” in block S261), the system processing unit 300 detects the current signal strength (e.g., continues monitoring the signal strength) (block S259). On the other hand, in response to the current signal strength being lower than or less than, by the predetermined strength or more, than the stored signal strength (that is, the current signal strength is less than the threshold value) (e.g., a “YES” in block S261), the system processing unit 300 controls the operating state of the electronic apparatus 1 to function/operate in the lock state (block S263).

As described above, the electronic apparatus 1A according to various embodiments includes the person detection unit 210 to detect the approach of a person. Then, based on the comparison result between the signal strength detected by the person detection unit 210 at the time of detecting the approach of a person and the currently detected signal strength, the operation control unit 326 controls the operating state of the electronic apparatus 1 to the lock state. Thus, since the electronic apparatus 1A calibrates the determination threshold value using the signal strength detected at the time of detecting the approach of a person (e.g., the signal strength when the user is nearby), the distance used to determine that the user has left can be set shorter or smaller while considering the influence of the surrounding environment or the like. Therefore, the distance for automatic locking when the user has left the electronic apparatus 1A can be made shorter or smaller than conventional techniques, and hence security in the electronic apparatus 1 can be improved.

In various embodiments, the electronic apparatus 1A may control the operating state of the system to the lock state based on the comparison result between the signal strength, detected in response to detecting the approach of a person to the electronic apparatus 1A (Approach) and the currently detected signal strength. Note that the electronic apparatus 1A may also control the operating state of the system to the lock state based on the comparison result between the signal strength, detected at any timing in a state where the presence of a person is being detected (Presence) and the currently detected signal strength.

In certain embodiments, the example in which the electronic apparatus 1A uses the proximity sensor 130 to detect that the user is nearby is described, but the method of detecting that the user is nearby is not limited to this example. For example, the electronic apparatus 1A may detect a person using a face detection function from a captured image captured by the imaging unit 120 to detect whether the user is nearby or not based on whether a person (e.g., the user) is in the image or not. Further, the electronic apparatus 1A may detect whether the user is nearby or not based simply on the presence or absence of an operation to the input device 150.

While the embodiments of the present technology have been described in detail above with reference to the accompanying drawings, the specific configuration is not limited to those in the above-described embodiments, and design changes and the like are included without departing from the scope of this invention. The respective components described in the above-described respective embodiments can be combined arbitrarily.

In each of the above embodiments, the configuration example in which the imaging unit 120 is incorporated in the electronic apparatus 1 (1A) has been described, but the configuration is not limited to this example. For example, the imaging unit 120 does not have to be incorporated in the electronic apparatus 1 (1A), which may be connected to the electronic apparatus 1 (1A) wirelessly or by wire as an external accessory of the electronic apparatus 1 (1A).

Further, in the above embodiments, the EC 200 configured to operate independently of the system processing unit 300 may be any processing unit such as a sensor hub or a chipset, and the above-described processing may be executed by any processing unit other than the EC 200 instead of the EC 200. It is usually the case that the sum of power consumption of the processing unit such as this EC 200 and the proximity sensor 130 is significantly less than the power consumption of the system processing unit 300.

Note that the above-described electronic apparatus 1 (1A) has a computer system therein. Then, a program for implementing the function of each component included in the above-described electronic apparatus 1 (1A) may be recorded on a computer-readable recording medium so that the program recorded on this recording medium is read into the computer system and executed to perform processing in each component included in the above-described electronic apparatus 1 (1A). Here, the fact that “the program recorded on the recording medium is read into the computer system and executed” includes installing the program on the computer system. It is presumed that the “computer system” here includes the OS and hardware such as a peripheral device and the like. Further, the “computer system” may also include two or more computers connected through a network including the Internet, WAN, LAN, and a communication line such as a dedicated line. Further, the “computer-readable recording medium” means a storage medium such as a flexible disk, a magneto-optical disk, a ROM, a portable medium like a CD-ROM, or a hard disk incorporated in the computer system. The recording medium with the program thus stored thereon may be a non-transitory recording medium such as the CD-ROM.

A recording medium internally or externally provided to be accessible from a delivery server for delivering the program is included as the recording medium. Note that the program may be divided into plural pieces, downloaded at different times, respectively, and then united in each component included in the electronic apparatus 1 (1A), or delivery servers for delivering respective divided pieces of the program may be different from one another. Further, the “computer-readable recording medium” includes a medium on which the program is held for a given length of time, such as a volatile memory (RAM) inside a computer system as a server or a client when the program is transmitted through the network. The above-mentioned program may also be to implement some of the functions described above. Further, the program may be a so-called differential file (differential program) capable of implementing the above-described functions in combination with a program(s) already recorded in the computer system.

Further, some or all of the functions of the electronic apparatus 1 (1A) may be realized as an integrated circuit, such as Large-Scale Integration (LSI). Each function may be a processor implemented individually, or part or whole thereof may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

Note that the electronic apparatus 1 (1A) may be a tablet PC, a smartphone, or the like. Further, the mobile terminal 500 is not limited to the smartphone, and it may be a smart watch, a beacon transmitter, or the like. Further, the near field communication between the electronic apparatus 1 (1A) and the mobile terminal 500 is not limited to Bluetooth®, and it may be any other communication such as wireless LAN or Wi-fi®. Further, it may be near field communication using a non-contact IC, such as Radio Frequency Identifier (RFID). In this case, the mobile terminal 500 may be a card with the non-contact IC thereon.

Further, for example, although a laptop PC is mentioned as an example of an electronic apparatus 1 in the above-described embodiments, the present technology is not limited to a laptop PC, and the present technology is applicable to other types of electronic devices such as, for example, tablets, cellular telephones, desktop computing devices, personal digital assistants, etc., and the like electronic apparatuses.

While the present technology has been described in each form, the technical scope of the present technology is not limited to the scope of the above-described aspects, and various combinations, changes, or improvements can be added without departing from the scope of the technology. The forms to which the combinations, changes, or improvements are added shall also be included in the technical scope of the present technology.

Embodiments may be practiced in other specific forms. The described embodiments are to be considered in all respects only as illustrative and not restrictive. The scope of the technology is, therefore, indicated by the appended claims rather than by the foregoing description. All changes which come within the meaning and range of equivalency of the claims are to be embraced within their scope.

1. A system, comprising:
a signal strength detection unit that detects a signal strength from an external device with which communication is connected wirelessly to an electronic apparatus; and
an operation control unit that controls an operating state of the electronic apparatus to a lock state based on a comparison between an initial signal strength, detected by the signal strength detection unit at a predetermined time, and a currently detected signal strength,
wherein at least a portion of each of said units comprises one or more of a set of hardware circuits, a set of programmable hardware devices, and executable code stored on a set of non-transitory computer-readable storage media.

2. The system of claim 1, wherein:
the processing unit executes a login process based on an authentication process;
the authentication process is based on input information; and
the predetermined time is a time based on the login process.

3. The system of claim 1, further comprising:
a person detection unit that detects approach of a person to the electronic apparatus,
wherein the predetermined time is a time that the person detection unit detects the approach of the person.

4. The system of claim 1, further comprising:
a display unit,
wherein the operation control unit displays a preset image on the display unit in the lock state.

5. The system of claim 1, further comprising:
a display unit,
wherein the operation control unit controls the display unit to hide displayed data in the lock state.

6. The system of claim 1, further comprising:
a storage unit that stores the initial signal strength detected by the signal strength detection unit at the predetermined time,
wherein, in response to the currently detected signal strength being less than the initial signal strength, by a predetermined amount, the operation control unit controls the operating state of the electronic apparatus to the lock state.

7. The system of claim 6, wherein, in response to detecting that the electronic apparatus is moved, the initial signal strength stored by the storage unit is disabled.

8. The system of claim 1, wherein the operation control unit releases the lock state of the electronic apparatus based on a user authentication process.

9. The system of claim 1, wherein the signal strength from the external device corresponds to a distance that a user is away from the electronic apparatus.

10. An apparatus, comprising:
a processor of an information handling device; and
a memory configured to store code executable by the processor to:
detect a signal strength from an external device with which communication is connected wirelessly to the information handling device, and
control an operating state of the information handling device to a lock state based on a comparison between an initial signal strength detected at a predetermined time and a currently detected signal strength.

11. The apparatus of claim 10, wherein:
the processor is further configured to execute a login process based on an authentication process;
the authentication process is based on input information; and
the predetermined time is a time based on the login process.

12. The apparatus of claim 10, wherein:
the processor is further configured to detect an approach of a person to the information handling device; and
the predetermined time is a time that the approach of the person is detected.

13. The apparatus of claim 10, wherein the processor is further configured to display a preset image on a display unit of the information handling device in the lock state.

14. The apparatus of claim 10, wherein the processor is further configured to hide displayed data on a display of the information handling device in the lock state.

15. The apparatus of claim 10, wherein the processor is further configured to:
store, in the memory, the initial signal strength detected at the predetermined time; and
control the operating state of the information handling device to the lock state in response to the currently detected signal strength being less than the initial signal strength by a predetermined amount.

16. The apparatus of claim 15, wherein the processor is further configured to disable the initial signal strength stored in the memory in response to detecting that the information handling device is moved.

17. The apparatus of claim 10, wherein the processor is further configured to release the lock state of the information handling device based on a user authentication process.

18. The apparatus of claim 10, wherein the signal strength from the external device corresponds to a distance that a user is away from the information handling device.

19. A method, comprising:
detecting, by a sensor of an information handling device, a signal strength from an external device with which communication is connected wirelessly to the information handling device; and
controlling, by a processor of the information handling device, an operating state of the information handling device to a lock state based on a comparison between an initial signal strength detected at a predetermined time and a currently detected signal strength.

20. The method of claim 19, wherein the signal strength from the external device corresponds to a distance that a user is away from the information handling device.
